(19) United States
(12) Patent Application Publication
(10) Pub. No.: US 2012/0011186 A1
(43) Pub. Date: Jan. 12, 2012

(54) METHOD FOR QUANTIFYING AND ANALYZING INTRINSIC PARALLELISM OF AN ALGORITHM

(75) Inventors: Gwo-Giun Chris Lee, LOS ALTOS, CA (US); He-Yuan Lin, Kaohsiung County (TW)

(73) Assignee: National Cheng Kung University, Tainan City (TW)

(21) Appl. No.: 12/832,557

(22) Filed: Jul. 8, 2010

(51) Int. Cl. G06F 15/00

(52) U.S. Cl. 708/517; 708/520

(57) ABSTRACT

A method for quantifying and analyzing intrinsic parallelism of an algorithm is adapted to be implemented by a computer, and includes the steps of: configuring the computer to represent the algorithm by means of a plurality of operation sets; configuring the computer to obtain a Laplacian matrix according to the operation sets; configuring the computer to compute eigenvalues and eigenvectors of the Laplacian matrix; and configuring the computer to obtain a set of information related to intrinsic parallelism of the algorithm according to the eigenvalues and the eigenvectors of the Laplacian matrix.

### BACKGROUND OF THE INVENTION

1. Field of the Invention

Embodiments of the present invention relates to a method for quantifying and analyzing parallelism of an algorithm, more particularly to a method for quantifying and analyzing intrinsic parallelism of an algorithm.

2. Description of the Related Art

G. M. Amdahl introduced a method for parallelization of an algorithm according to a ratio of sequential portion of the algorithm (“Validity of single-processor approach to achieving large-scale computing capability,” Proc. of AFIPS Conference, pages 483-485, 1967). A drawback of Amdahl's method is that a degree of parallelism of the algorithm obtained using the method is dependent on a target platform executing the method, and is not necessarily dependent on the algorithm itself. Therefore, the degree of parallelism obtained using Amdahl's method is extrinsic to the algorithm and is biased by the target platform.

A. Prihozhy et al. proposed a method for evaluating parallelization potential of an algorithm based on a ratio between complexity and a critical path length of the algorithm (“Evaluation of the parallelization potential for efficient multimedia implementations: dynamic evaluation of algorithm critical path,” IEEE Trans. on Circuits and Systems for Video Technology, pages 593-608, Vol. 15, No. 5, May 2005). The complexity is a total number of operations in the algorithm, and the critical path length is the largest number of operations that need to be sequentially executed due to computational data dependencies. Although the method may characterize an average degree of parallelism embedded in the algorithm, it is insufficient for exhaustively characterizing versatile multigrain parallelisms embedded in the algorithm.

### SUMMARY OF THE INVENTION

Therefore, embodiments of the present invention provides a method for quantifying and analyzing intrinsic parallelism of an algorithm that is not susceptible to bias by a target hardware and/or software platform.

Accordingly, in accordance with some embodiments, a method of the present invention for quantifying and analyzing intrinsic parallelism of an algorithm is adapted to be implemented by a computer and comprises the steps of:
a) configuring the computer to represent the algorithm by means of a plurality of operation sets;
b) configuring the computer to obtain a Laplacian matrix according to the operation sets;
c) configuring the computer to compute eigenvalues and eigenvectors of the Laplacian matrix; and
d) configuring the computer to obtain a set of information related to intrinsic parallelism of the algorithm according to the eigenvalues and the eigenvectors of the Laplacian matrix.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart illustrating a preferred embodiment of a method for quantifying and analyzing intrinsic parallelism of an algorithm according to the present invention;

FIG. 2 is a schematic diagram illustrating dataflow information related to an exemplary algorithm;

FIG. 3 is a schematic diagram of an exemplary set of dataflow graphs;

FIG. 4 is a schematic diagram illustrating operation sets of a 4×4 discrete cosine transform algorithm;

FIG. 5 is a schematic diagram illustrating an exemplary composition of intrinsic parallelism corresponding to a dependency depth equal to 6;

FIG. 6 is a schematic diagram illustrating an exemplary composition of intrinsic parallelism corresponding to a dependency depth equal to 5; and

FIG. 7 is a schematic diagram illustrating an exemplary composition of intrinsic parallelism corresponding to a dependency depth equal to 3.

### DETAILED DESCRIPTION OF THE PREFERRED EMBODIMENT

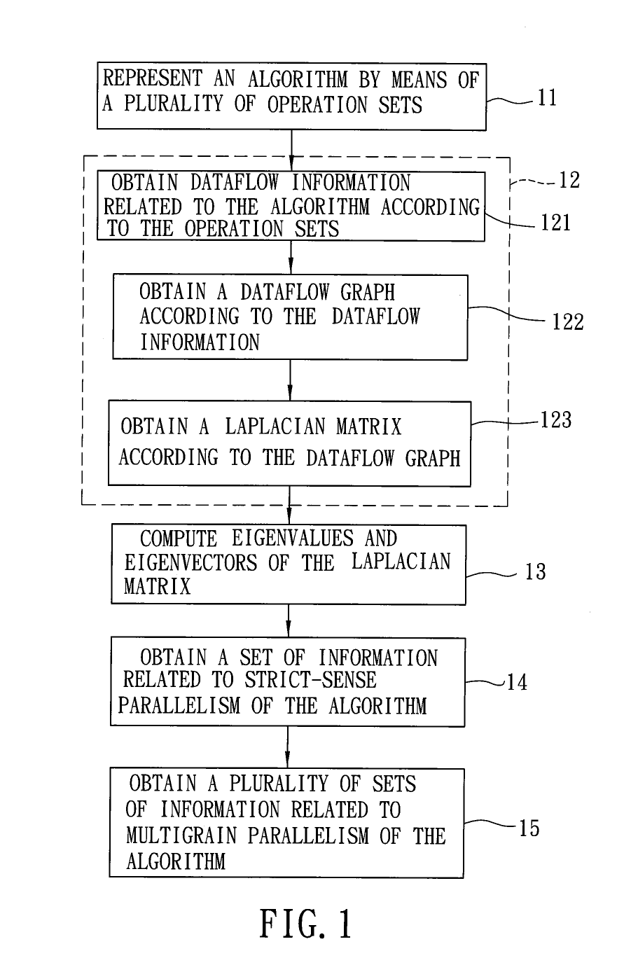

Referring to FIG. 1, a preferred embodiment of a method according to the present invention for evaluating intrinsic parallelism of an algorithm is adapted to be implemented by a computer, and includes the following steps. A degree of intrinsic parallelism indicates a degree of parallelism of an algorithm itself without considering designs and configuration of software and hardware, that is to say, the method according to this invention is not limited by software and hardware when it is used for analyzing an algorithm.

In step 11, the computer is configured to represent an algorithm by means of a plurality of operation sets. Each of the operation sets may be an equation, a program code, a flow chart, or any other form for expressing the algorithm. In the following example, the algorithm includes three operation sets O1, O2 and O3 that are expressed as

O1=Ai+B1+C1+D1,

O2=A2+B2+C2, and

O3=A₃+B₃+C₃.

Step 12 is to configure the computer to obtain a Laplacian matrix L_{d} according to the operation sets, and includes the following sub-steps.

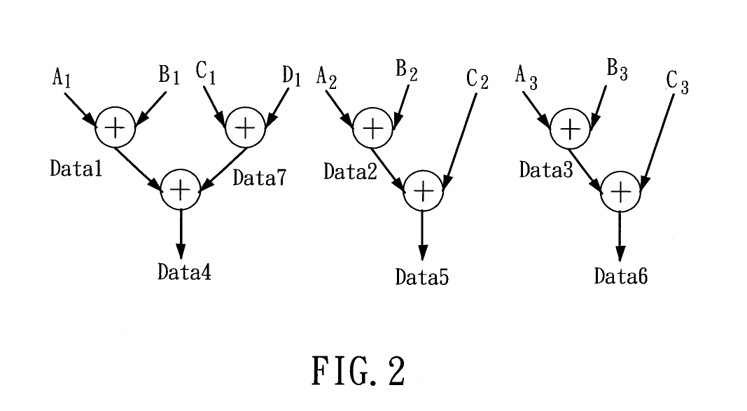

In sub-step 121, according to the operation sets, the computer is configured to obtain dataflow information related to the algorithm. As shown in FIG. 2, the dataflow information corresponding to the operation sets of the example may be expressed as follows.

Data1=A₁+B₁

Data2=A2+B2

Data3=A₃+B₃

Data4=Data1+Data7

Data5=Data2+C₂

Data6=Data3+C₃

Data7=C₁+D₁

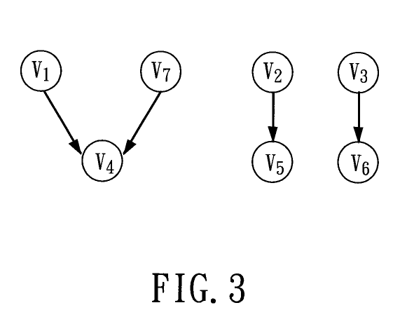

In sub-step 122, the computer is configured to obtain a dataflow graph according to the dataflow information. The dataflow graph is composed of a plurality of vertexes that denote operations in the algorithm, and a plurality of directed edges that indicate interconnection between corresponding two of the vertexes and that represent sources and destinations of data in the algorithm. For the dataflow information shown in FIG. 2, operator symbols V₁ to V₇ (i.e., the vertexes) are used instead of addition operators and arrows (i.e., the directed edges) represent the sources and destinations of data to thereby obtain the dataflow graph as shown in FIG. 3. In particular, the operator symbol V₁ represents the addition operation for A₁+B₁, the operator symbol V₂ represents the addition operation for A₂+B₂, the operator symbol V₃ represents the addition operation for A₃+B₃, the operator symbol V₄ represents the addition operation for Data1+Data7, the operator symbol V₅ represents the addition operation for Data2+C₂, the operator symbol V₆ represents the addition operation for Data3+C₃, and the operator symbol V₇ represents the addition operation for D₁+C₁.

From the dataflow graph shown in FIG. 3, it can be appreciated that the operator symbol V₄ is dependent on the operator symbols V₁ and V₇. Similarly, the operator symbol V₅ is dependent on the operator symbol V₂, the operator symbol V₆ is dependent on the operator symbol V₃, and the operator symbols V₄, V₅ and V₆ are independent of each other.

In sub-step 123, the computer is configured to obtain the Laplacian matrix L_{d} according to the dataflow graphs. In the Laplacian matrix L_{d}, the i^{th} diagonal element shows a number of operator symbols that are connected to the operator symbol Vi, and the off-diagonal element denotes whether two operator symbols are connected. Therefore, the Laplacian matrix Ld can clearly express the dataflow graphs by a compact linear algebraic form. The set of dataflow graphs shown in FIG. 3 may be expressed as follows.

$${L}_{d} = [ \begin{matrix}1 & 0 & 0 & - 1 & 0 & 0 & 0 \\ 0 & 1 & 0 & 0 & - 1 & 0 & 0 \\ 0 & 0 & 1 & 0 & 0 & - 1 & 0 \\ - 1 & 0 & 0 & 2 & 0 & 0 & - 1 \\ 0 & - 1 & 0 & 0 & 1 & 0 & 0 \\ 0 & 0 & - 1 & 0 & 0 & 1 & 0 \\ 0 & 0 & 0 & - 1 & 0 & 0 & 1\end{matrix} ]$$

The Laplacian matrix L_{d} represents connectivity among the operator symbols V₁ to V₇, and the first column to the seventh column represent the operator symbols V₁ to V₇, respectively. For example, in the first column, the operator symbol V₁ is connected to the operator symbol V₄, and thus the matrix element (1,4) is −1.

In step 13, the computer is configured to compute eigenvalues λ and eigenvectors X_{d} of the Laplacian matrix L_{d}. Regarding the Laplacian matrix L_{d} obtained in the above example, the eigenvalues sand the eigenvectors X_{d} are

$$λ = [ \begin{matrix}0 & 0 & 0 & 1 & 2 & 2 & 3\end{matrix} ] , and$$

$${X}_{d} = [ \begin{matrix}1 \\ 0 \\ 0 \\ 1 \\ 0 \\ 0 \\ 1\end{matrix} ] [ \begin{matrix}0 \\ 1 \\ 0 \\ 0 \\ 1 \\ 0 \\ 0\end{matrix} ] [ \begin{matrix}0 \\ 0 \\ 1 \\ 0 \\ 0 \\ 1 \\ 0\end{matrix} ] [ \begin{matrix}- 1 \\ 0 \\ 0 \\ 0 \\ 0 \\ 0 \\ 1\end{matrix} ] [ \begin{matrix}0 \\ 1 \\ 0 \\ 0 \\ - 1 \\ 0 \\ 0\end{matrix} ] [ \begin{matrix}0 \\ 0 \\ 1 \\ 0 \\ 0 \\ - 1 \\ 0\end{matrix} ] [ \begin{matrix}1 \\ 0 \\ 0 \\ - 2 \\ 0 \\ 0 \\ 1\end{matrix} ] .$$

In step 14, the computer is configured to obtain a set of information related to intrinsic parallelism of the algorithm according to the eigenvalues λ and the eigenvectors X_{d} of the Laplacian matrix Ld. The set of information related to intrinsic parallelism is defined in a strict manner to recognize independent ones of the operation sets that are independent of each other and hence can be executed in parallel. The set of information related to strict-sense parallelism includes a degree of strict-sense parallelism representing a number of independent ones of the operation sets of the algorithm, and a set of compositions of strict-sense parallelism corresponding to the operation sets, respectively.

Based on spectral graph theory introduced by F. R. K. Chung (Regional Conferences Series in Mathematics, No. 92, 1997), a number of connected components in a graph is equal to a number of the eigenvalues of the Laplacian matrix that are equal to 0. The degree of strict-sense parallelism embedded within the algorithm is thus equal to a number of eigenvalues A, that are equal to 0. Besides, based on the spectral graph theory, the compositions of strict-sense parallelism may be identified according to the eigenvectors X_{d} associated with the eigenvalues λ that are equal to 0.

From the above example, it can be found that the set of dataflow graphs is composed of three independent operation sets, since there exist three Laplacian eigenvalues that are equal to 0. Thus, the degree of strict-sense parallelism embedded in the exemplified algorithm is equal to 3. Subsequently, the first, second and third ones of the eigenvectors X_{d} are associated with the eigenvalues λ that are equal to 0. By observing the first one of the eigenvectors X_{d}, it is clear that the values corresponding to the operator symbols V₁, V₄ and V₇ are non-zero, that is to say, the operator symbols V₁, V₄ and V₇ are dependent and form a connected one (V₁-V₄-V₇) of the dataflow graph. Similarly, from the second and third ones of the eigenvectors X_{d} associated with the eigenvalues λ, that are equal to 0, it can be appreciated that the operator symbols V₂, V₅ and the operator symbols V₃, V₆ are dependent and form the remaining two connected ones (V₂-V₅ and V₃-V₆) of the dataflow graph, respectively. Therefore, the computer is configured to obtain the degree of strict-sense parallelism that is equal to 3, and the compositions of strict-sense parallelism that may be expressed in the form of a graph (shown in FIG. 3), a table, equations, or program codes.

In step 15, the computer is configured to obtain a plurality of sets of information related to multigrain parallelism of the algorithm according to the set of information related to strict-sense parallelism and at least one of a plurality of dependency depths of the algorithm. The sets of information related to multigrain parallelism include a set of information related to wide-sense parallelism of the algorithm that characterizes all possible parallelisms embedded in an independent operation set.

It should be noted that the dependency depths of an algorithm represent associated sequential steps essential for processing the algorithm, and thus are complementary to potential parallelism of the algorithm. Thus, information related to different intrinsic parallelisms of an algorithm may be obtained based on different dependency depths. In particular, the information related to strict-sense parallelism is the information related to intrinsic parallelism of the algorithm corresponding to a maximum one of the dependency depths of the algorithm, and the information related to wide-sense parallelism is the information related to intrinsic parallelism of the algorithm corresponding to a minimum one of the dependency depths.

For example, the above-mentioned algorithm includes two different compositions of strict-sense parallelism, i.e., V₁-V₄-V₇ and V₂-V₅ (V₃-V₆ is similar to V₂-V₅ and can be considered to be the same composition). Regarding the composition of the strict-sense parallelism V₁-V₄-V₇, it can be known that the operator symbols V₁ and V₇ are independent of each other, i.e., the operator symbols V₁ and V₇ can be processed in parallel. Therefore; the set of information related to wide-sense parallelism of the algorithm includes a degree of wide-sense parallelism that is equal to 4, and compositions of wide-sense parallelism are similar to the compositions of strict-sense parallelism.

According to the method of this embodiment, the degree of wide-sense parallelism of the above-mentioned algorithm is equal to 4. It is assumed that a processing element requires 7 processing cycles for implementing the algorithm, since the algorithm includes 7 operator symbols V₁-V₇. According to the degree of strict-sense parallelism that is equal to 3, using 3 processing elements to implement the algorithm will take up 3 processing cycles. According to the degree of wide-sense parallelism that is equal to 4, using 4 processing elements to implement the algorithm will take up 2 processing cycles. Further, it can be known that at least 2 processing cycles are necessary for implementing the algorithm even though more processing elements are used. Therefore, an optimum number of processing elements used for implementing an algorithm may be obtained according to the method of this embodiment.

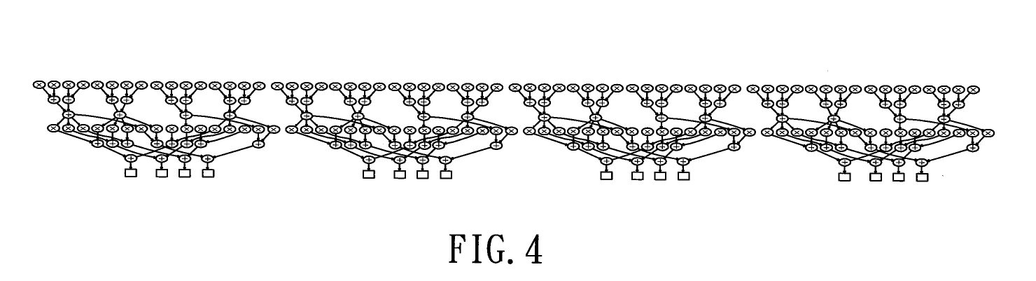

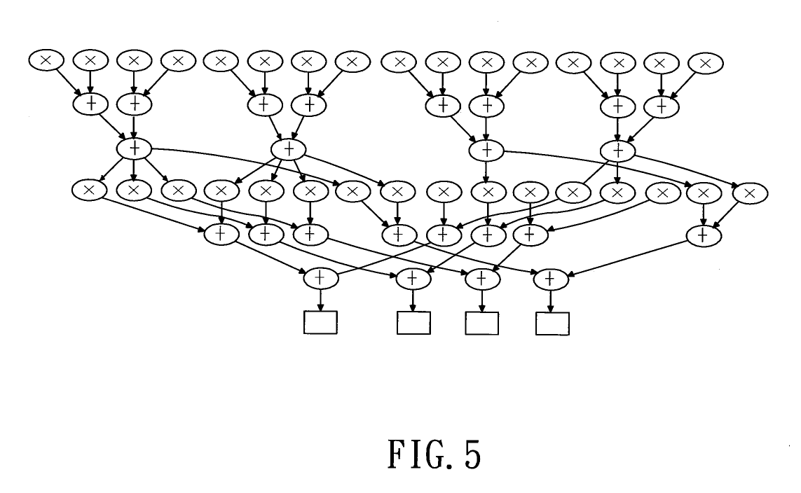

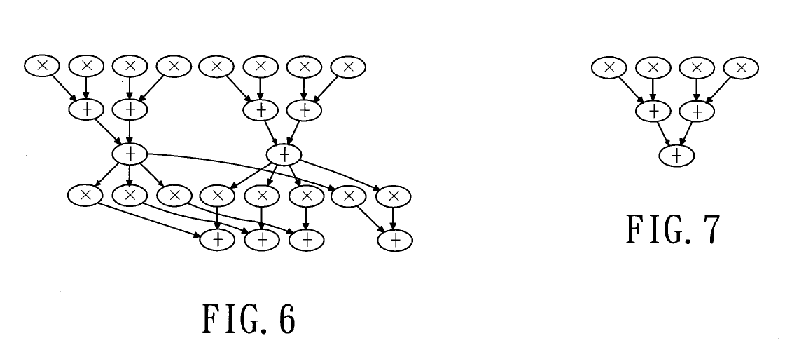

Taking a 4×4 discrete cosine transform (DCT) as an example, operation sets of the DCT algorithm are represented by dataflow graphs as shown in FIG. 4. Since the 4×4 DCT is well known to those skilled in the art, further details thereof will be omitted herein for the sake of brevity. From FIG. 4, it can be known that the maximum one of the dependency depths of the 4×4 DCT algorithm is equal to 6. Regarding the maximum one of the dependency depths (i.e., 6), the composition of strict-sense parallelism of this algorithm may be obtained as shown in FIG. 5, and the degree of strict-sense parallelism of this algorithm is equal to 4 according to the method of this embodiment. When analyzing the intrinsic parallelism of the 4×4 DCT algorithm with one of the dependency depths that is equal to 5, the composition of intrinsic parallelism of this algorithm may be obtained as shown in FIG. 6, and the degree of intrinsic parallelism is equal to 8. Further, when analyzing the intrinsic parallelism of the 4×4 DCT algorithm with one of the dependency depths that is equal to 3, the composition of intrinsic parallelism of this algorithm may be obtained as shown in FIG. 7, and the degree of intrinsic parallelism is equal to 16.

In summary, the method according to this invention may be used to evaluate the intrinsic parallelism of an algorithm.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for quantifying and analyzing intrinsic parallelism of an algorithm, said method being adapted to be implemented by a computer and comprising the steps of:
a) configuring the computer to represent the algorithm by means of a plurality of operation sets;
b) configuring the computer to obtain a Laplacian matrix according to the plurality of operation sets;
c) configuring the computer to compute eigenvalues and eigenvectors of the Laplacian matrix; and
d) configuring the computer to obtain a set of information related to intrinsic parallelism of the algorithm according to the eigenvalues and the eigenvectors of the Laplacian matrix.

2. The method as claimed in claim 1, wherein step b) includes the following sub-steps of:
b1) according to the plurality of operation sets, configuring the computer to obtain dataflow information related to the algorithm; and
b2) according to the dataflow information, configuring the computer to obtain a dataflow graph composed of a plurality of vertexes that denote operations in the algorithm, and a plurality of directed edges that indicate interconnection between corresponding two of the vertexes and that represent sources and destinations of data in the algorithm; and
b3) configuring the computer to obtain the Laplacian matrix according to the dataflow graph.

3. The method as claimed in claim 1, wherein step d) includes the following sub-steps of:
d1) according to the eigenvalues and the eigenvectors of the Laplacian matrix, configuring the computer to obtain a set of information related to strict-sense parallelism of the algorithm; and
d2) configuring the computer to obtain a set of information related to multigrain parallelism of the algorithm according to the set of information related to strict-sense parallelism and at least one of a plurality of dependency depths of the algorithm.

4. The method as claimed in claim 3, wherein the set of information related to strict-sense parallelism includes a degree of strict-sense parallelism representing a number of independent ones of the operation sets of the algorithm, and a set of compositions of strict-sense parallelism corresponding to the operation sets, respectively.

5. The method as claimed in claim 3, wherein, in sub-step d2), the computer is configured to obtain a plurality of sets of information related to multigrain parallelism of the algorithm according to the set of information related to strict-sense parallelism and the dependency depths, respectively.

6. The method as claimed in claim 5, wherein each of the sets of information related to multigrain parallelism includes a degree of multigrain parallelism, and a set of compositions of multigrain parallelism.

7. The method as claimed in claim 3, wherein the set of information related to multigrain parallelism includes a set of information related to wide-sense parallelism of the algorithm that is obtained according to the set of information related to strict-sense parallelism and a minimum one of the dependency depths.

8. The method as claimed in claim 7, wherein the set of information related to wide-sense parallelism includes a degree of wide-sense parallelism characterizing all possible parallelism embedded in independent ones of the operation sets of the algorithm, and a set of compositions of wide-sense parallelism.

9. The method as claimed in claim 3, wherein, in sub-step d1), the degree of strict-sense parallelism is equal to a number of the eigenvalues that are equal to 0 based on spectral graph theory.

10. The method as claimed in claim 3, wherein the information related to multigrain parallelism includes a degree of multigrain parallelism, and a set of compositions of multigrain parallelism.

11. A computer program product comprising a machine readable storage medium having program instructions stored therein which when executed cause a computer to perform a method for quantifying and analyzing intrinsic parallelism of an algorithm according to claim 1.
